(19) United States
(12) Patent Application Publication
(10) Pub. No.: US 2026/0078821 A1
(43) Pub. Date: Mar. 19, 2026

(54) ELECTRIC DRIVETRAIN

(71) Applicant: Traton AB, Södertälje (SE)

(72) Inventors: Ismael Hernandez, Algonquin, IL (US); Pawel Konieczek, Willowbrook, IL (US); Grzegorz Siuchta, Des Plaines, IL (US); Steven Randall Lovell, Oswego, IL (US); Tobias Bergdal, Trosa (SE); Mikael Bergquist, Huddinge (SE); Per Arnelöf, Vendelsö (SE)

(73) Assignee: Traton AB, Södertälje (SE)

(21) Appl. No.: 19/325,604

(22) Filed: Sep. 11, 2025

Related U.S. Application Data
(60) Provisional application No. 63/695,556, filed on Sep. 17, 2024.

(51) Int. Cl. F16H 63/34; F16D 55/225; F16D 65/18; F16D 121/18; F16D 125/48; F16H 37/08

(52) U.S. Cl. CPC F16H 63/345; F16D 55/225; F16D 65/183; F16H 37/0813; F16H 63/3458; F16D 2121/18; F16D 2125/48

(57) ABSTRACT

An electric drivetrain adapted to be installed in a vehicle to control movement of the vehicle. The electric drivetrain includes: a gear box adapted to be operatively coupled to wheels of the vehicle, wherein the gear box includes a differential; a multiplication gear assembly operatively coupled to the differential; and a parking brake assembly coupled to the multiplication gear assembly. The multiplication gear assembly includes a first gear and a second gear operatively coupled to the first gear to reduce a braking torque required by the parking brake assembly to secure the vehicle in park.

### CROSS-REFERENCE TO RELATED APPLICATION(S)

The present patent application claims the priority benefit of U.S. Provisional Application No. 63/695,556, filed Sep. 17, 2024, and titled “Electro-Mechanical Parking Brake System Integrated with Electric Drive Axle for Commercial Vehicle Applications,” the entirety of which is hereby incorporated by reference herein.

### FIELD OF THE DISCLOSURE

The present disclosure generally relates to brake systems for electric drivetrains and, more particularly, to a brake system designed to improve redundancy.

### BACKGROUND

Traditionally, vehicles equipped with internal combustion engines (ICE) and electric vehicles (EVs) utilized a transmission brake or driveline parking brake to applies a braking force to the drivetrain that drives the wheels on the rear axle rather than directly to the wheels. This arrangement leverages the differential ratio to effectively park the vehicle by utilizing less torque. However, the introduction of electrified axles, which integrate electromotive elements directly within the axle assembly, negates the requirement for a traditional driveshaft, driving the industry to attempt to implement parking brake systems at the wheel level. This has posed significant hurdles, however, chiefly due to the elevated torque requirements needed to securely hold vehicles (particularly heavy-duty vehicles) stationary, presenting cost and complexity challenges in implementing effective braking systems at the wheel level. Moreover, the lack of redundancy in brake systems, particularly in the context of an evolving automotive landscape that encompasses heavy-duty commercial vehicles, compounds the challenge of ensuring reliability and safety.

### SUMMARY

In accordance with a first exemplary aspect of the present disclosure, an electric drivetrain is provided. The electric drivetrain is adapted to be installed in a vehicle to control movement of the vehicle. The electric drivetrain includes: a gear box adapted to be operatively coupled to wheels of the vehicle, wherein the gear box includes a differential; a multiplication gear assembly operatively coupled to the differential; and a parking brake assembly coupled to the multiplication gear assembly. The multiplication gear assembly includes a first gear and a second gear operatively coupled to the first gear to reduce a braking torque required by the parking brake assembly to secure the vehicle in park.

In accordance with a second exemplary aspect of the present disclosure, an electric drivetrain is provided. The electric drivetrain is adapted to be installed in a vehicle to control movement of the vehicle. The electric drivetrain includes: an electric motor; a gear box operatively coupled to the electric motor, wherein the gear box includes a differential; a multiplication gear assembly operatively coupled to the differential; and a parking brake assembly coupled to the multiplication gear assembly. The multiplication gear assembly includes a first gear and a second gear operatively coupled to the first gear to reduce a braking torque required by the parking brake assembly to secure the vehicle in park. The multiplication gear assembly is removably coupled to the gear box.

In accordance with a third exemplary aspect of the present disclosure, a drivetrain system is provided. The drivetrain system is adapted to be installed in a vehicle. The drivetrain system includes: a gear box; a multiplication gear assembly operatively coupled to the gear box; an electric parking brake assembly operatively coupled to the multiplication gear assembly; and a control system configured to selectively actuate the electric parking brake assembly. The multiplication gear assembly includes a first gear and a second gear operatively coupled to the first gear to reduce a braking torque required by the electric parking brake assembly to secure the vehicle in park.

In some aspects, the multiplication gear assembly further includes: a first shaft having a first end and second end opposite the first end, wherein the first end is coupled to at least a portion of the differential and the second end is coupled to the first gear; and a second shaft coupled to the second gear. The first shaft and the second shaft may rotate in opposite directions.

In some aspects, the first shaft is arranged axially parallel to the second shaft.

In some aspects, the first gear has an outer diameter that is greater than an outer diameter of the second gear.

In some aspects, the parking brake assembly includes: a brake disk operatively coupled to the multiplication gear assembly; and a plurality of parking brake calipers operatively coupled to the brake disk. The plurality of parking brake calipers is configured to selectively engage the brake disk to slow the rotation of the brake disk.

In some aspects, the plurality of parking brake calipers includes a first brake caliper and a second brake caliper that is operable independent of the first brake caliper.

In some aspects, the multiplication gear assembly is removably coupled to the differential.

In some aspects, the multiplication gear assembly further includes a casing configured for enclosing at least a portion of the first shaft, the second shaft, the first gear, and the second gear.

In some aspects, the first gear and the second gear are entirely disposed within the casing.

In some aspects, the control system includes: a first electronic control unit (ECU) electrically connected to the first parking brake caliper and configured to control the first parking brake caliper; a second electronic control unit (ECU) electrically connected to the second parking brake caliper and configured to control the second parking brake caliper; a first power source electrically connected to the first parking brake caliper; a second power source electrically connected to the second parking brake caliper; and an electronic hand control unit electrically connected to the first and second ECUs and configured for sending an input to the first and second ECUs to activate the first and second parking brake calipers, respectively.

In some aspects, the drivetrain system includes a plurality of service brakes, wherein at least one of the plurality of service brakes is electrically connected to the first ECU and at least one of the plurality of service brakes is electrically connected to the second ECU.

In some aspects, the control system includes: one or more electronic control units (ECUs) electrically connected to at least one of the first and second parking brake calipers and configured to control at least one of the first and second parking brake calipers; a first power source configured to power the ECUs; and a second power source configured to redundantly power the ECUs in the event the first power source fails. The second parking brake caliper provides redundancy in the event the first parking brake caliper fails.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate examples of concepts that include the claimed invention, and explain various principles and advantages of those examples.

FIG. 1 shows a top, schematic view of one example of an electric drivetrain constructed in accordance with the teachings of the present disclosure.

FIG. 2 shows another schematic view of the electric drivetrain of FIG. 1.

FIG. 3 shows a side view of the electric drivetrain of FIG. 1.

FIG. 4 shows a schematic diagram of one example of a braking system that is constructed in accordance with the teachings of the present disclosure and integrates the electric drivetrain of FIG. 1.

FIG. 5 shows a schematic diagram of another example of a braking system that is constructed in accordance with the teachings of the present disclosure and includes the electric drivetrain of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples. Also, common but well-understood elements that are useful or necessary in a commercially feasible examples are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

The apparatus and method components have been represented where appropriate by conventional symbols in the drawings, showing only those specific details that are pertinent to understanding examples of the present disclosure so as not to obscure the disclosure with details that will be readily apparent to those of ordinary skill in the art having the benefit of the description herein.

Although the figures show parts with clean lines and boundaries, some or all of these lines and/or boundaries may be idealized. In reality, the boundaries and/or lines may be unobservable, blended, and/or irregular. Use of terms such as up, down, top, bottom, side, end, front, back, etc. herein are used with reference to a currently considered or illustrated orientation. If they are considered with respect to another orientation, it should be understood that such terms must be correspondingly modified.

### DETAILED DESCRIPTION

The present disclosure aims to address problems related to the parking brake systems discussed above, conventional electric drivetrains, and other engine designs, such as the design disclosed in U.S. Patent Publication No. 2024/0271699, which builds off the conventional electric drivetrain to move the parking brake before the final gear and differential on the gearbox. However, although this particular design may provide for a more powerful braking torque, it suffers from safety issues, as it must deal with the shiftability of the gear box and/or risk the scenario in which the parking brake needs to be applied when a gear is not applied. Moreover, given the significant torque necessary when applying the parking brake to the wheels in electric drivetrains, other current solutions are costly, prone to wear, and may be insufficient in applications with heavy duty vehicles. Therefore, the present disclosure provides an electric drivetrain that is generally configured to reduce the torque necessary, provides redundancy in the event of failure of one or more components, and is cheaper but still sufficient for use in heavy duty applications.

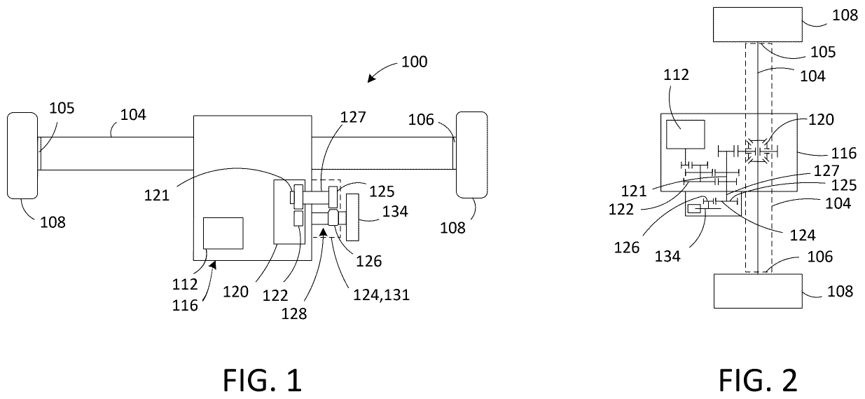

FIGS. 1-3 illustrate an electric drivetrain 100 constructed in accordance with the teachings of the present disclosure. The electric drivetrain 100 is generally configured to be installed in a vehicle (e.g., a truck or other heavy duty vehicle) to control movement of the vehicle. The electric drivetrain includes an axle 104, wheels 108 coupled to the axle 104, and an electric mover 112 operatively coupled to the axle 104 and wheels 108 to provide the necessary rotational energy for the wheels 108. The electric drivetrain 100 further includes a gear box 116 that is operatively coupled to the electric mover 112 and to the axle 104 and the wheels 108 to transfer the necessary rotational energy to the wheels 108 and includes a differential 120. The electric drivetrain 104 further includes a multiplication gear assembly 124 operatively coupled to the differential 120 and a parking brake assembly 134 coupled to the multiplication gear assembly 124 and configured to apply a braking force to the axle 104 and the wheels 108 to secure the vehicle in park.

The axle 104 is generally configured to transfer rotational energy from the gear box 116 to the wheels 108. The axle 104 is generally cylindrical and includes a first end 105 and a second end 106 opposite the first end 105. In the present example, the first and second ends 105, 106 are each coupled to one of the wheels 108. In other examples, the axle 104 may include additional components to allow for the first and second ends 105, 106 to be each coupled to multiple wheels 108. The electric mover 112 is intended to power the electric drivetrain 100 and includes a battery (not shown). One of skill in the art will appreciate that the electric motor may be of any suitable size, power, shape, and location relative to the gear box 116 depending on the type of vehicle and the power needs of the vehicle. In the present example, the electric mover 112 is an electric motor configured to power both of the wheels 108, but in other examples the electric drivetrain 100 may include more than one motor, including, for example, an electric mover powering each of the wheels 108 independently.

The gear box 116 is configured to operatively couple the parking brake assembly 134 to the axle 104 and the wheels 108 to allow for the braking torque to be applied. It will be appreciated that the gear box 116 may be of any suitable size, shape, material, and position relative to the axle 104 and wheels 108. For example, the gear box 116 may be positioned closer to or further from the axle 104 and the wheels 108 than what is illustrated in FIGS. 1 and 2. In the present example, the gear box 116 is coupled to a single axle 104 (e.g., the rear axle) and two wheels 108 of the vehicle (i.e., one wheel at each end of the axle 104), but in other examples the gear box 116 may be coupled to more than one axle (e.g., 2 or 3) and more than two wheels (e.g., 4, 6, or 8). Moreover, the gear box 116 may include other components (e.g., sensors or instruments for lubrication) that facilitate the functionality of the gear box 116.

The differential 120 is configured to distribute the rotational energy from the electric mover 112 to the wheels 108 at each end of the axle 104. In the present example, the differential 120 is disposed entirely within a housing 110 of the gear box 108 and includes two differential gears—a first differential gear 121 and a second differential gear 122 and operatively coupled to the first differential gear 121. The first and second differential gears 121, 122 are of conventional type, and it will be appreciated that the gears 121, 122 may be of any size, shape, material, and placement within the gear box 116. Moreover, although in the present example there are two differential gears, other examples may include more or less differential gears (e.g., 1, 3, 5, or 8), or the gear box 116 may not include any differential gears (e.g., when each of the wheels 108 of the electric drivetrain 100 is powered by an individual electric mover 112, thus negating the need for a differential 120).

The multiplication gear assembly 124 is configured to reduce the torque necessary to safely apply the required brake force to the axle 104 and wheels 108 of the electric drivetrain 100 to secure the vehicle in park. In the present example, the multiplication gear assembly 124 is a stand-alone assembly system separate from the gear box 116 and includes a first gear 125, a second gear 126, a first shaft 127, a second shaft 128, and a casing 131. The first gear 125 is operatively coupled to the first shaft 127. More particularly, the first gear 125 is carried on or at a first end of the first shaft 127 at a position outside of the gear box 116. The second gear 126 is coupled to the second shaft 128 and is operatively coupled to the first gear 125. More particularly, the second gear 126 is carried on the second shaft 128 at a position outside of the gear box 116. However, unlike the first gear 125, the second gear 126 is carried between the two ends of the second shaft 128, such that the second gear 126 is aligned with the first gear 125. The first shaft 127 is coupled to the differential 120 (specifically the first differential gear 121). The second shaft 128 is coupled to the parking brake assembly 134 and is isolated or decoupled from the gear box 116 such that, for example, issues with the parking brake assembly 134 will not harm the integrity of the gear box 116. The casing 131 is configured to partially if not fully enclose the first gear 125, the second gear 126, the first shaft 127, and the second shaft 128.

Generally speaking, and as schematically illustrated in FIGS. 1 and 2, an outer diameter 125a of the first gear 125 is greater than an outer diameter 126a of the second gear 126, such that the second gear 126 spins at a faster rate than the first gear 125. The exact ratio between the outer diameter 125a and the outer diameter 126 will depend on the vehicle, though the ratio should be sufficient so that the parking brake assembly 134 delivers sufficient braking force in a primary mode but also adequately performs in a back-up mode (e.g., if a caliper of the parking brake assembly 134 should fail). In the present example, the outer diameter 125a of the first gear 125 is twice the outer diameter 126a of the second gear 126. In other examples, however, the ratio between the outer diameter 125a and the outer diameter 126a may be more or less than 2:1. For example, the ratio between the outer diameter 113 and the outer diameter 126a may be 1.5:1, 3:1, 4:1, 7:2, or some other ratio.

The first shaft 127 is generally cylindrical and is coupled to the first gear 125 and the differential 120 (specifically the first differential gear 121) so as to transfer rotational energy between the differential 120 (specifically the first differential gear 121) and the first gear 125. The first shaft 127 includes a first end 129a on which the first gear 125 is disposed and a second end 129b that is opposite the first end 129a and is coupled to a least a portion of the differential 120. In the present example, the first shaft 127 is axially parallel to the axle 104 and is composed of a steel alloy, but it will be appreciated that any suitable hard material (e.g., aluminum, carbon fiber, or metal composites) may be used instead or as well. The second shaft 128 is substantially similar to the first shaft 127 but differs in a few respects. First, although the second shaft 128, like the first shaft 127, is axially parallel with the axle 104 (and thus arranged axially parallel to the first shaft 127), the first shaft 127 is disposed between the axle 104 and the second shaft 128. Said differently, the second shaft 128 is disposed farther from the axle 104 than the first shaft 127. The exact distance between the first and second shafts 127, 128 will depend on the size of the first gear 125 and the second gear 126. Second, the second shaft 128 includes a first end 130a coupled to the gear box 116 and a second end 130b that is opposite the first end 130a and operatively coupled to the parking brake assembly 134 outside of the casing 131. Third, the first shaft 127 and the second shaft 128 rotate in opposite directions when operatively coupled together by the engagement between the first gear 125 and the second gear 126. Fourth, the first and second shafts 127, 128, like the first and second gears 125, 126, rotate at different speeds. In any case, the second shaft 128, which is operatively coupled to the brake assembly 134, operates separate from the gearbox 116 that is driven by the electric mover 112 to ensure system reliability. Said differently, the brake assembly 134 is operable independent of which gear is engaged in the gearbox 116 (or even if no gear is engaged).

The casing 131 is configured to partially if not fully enclose and protect the components of the multiplication gear assembly 124 and to support the lubrication of the components of the multiplication gear assembly 124. In the present example, it will be appreciated that the casing 131 is shaped like two adjacent and parallel barrels, one for each of the first and second gears 125, 126. More particularly, the casing 131 includes a first, larger half that entirely encloses the first gear 125 and entirely encloses the first shaft 127, and a second, smaller half that entirely encloses the second gear 126 and least a portion of the second shaft 128. In other examples, the casing 131 may only partially enclose the first shaft 127 and/or fully enclose the second shaft 128. Moreover, the casing 131 may enclose only a portion of the first gear 125 and/or the second gear 126. The casing 131 includes an open end 131a removably coupled to the gear box and a hollow body 131b extending away from the open end 131a and defining the first, larger half and the second, smaller half. The casing 131 further includes an opening 131c (not shown) configured for receiving and retaining the second shaft 128 therein as the second shaft 128 extends from the gear box 116 to the parking brake assembly 134 outside of the gear box 116. In the present example, the casing 131 is removably coupled to the gear box 116 via a set of fasteners 132 (e.g., bolts or screws), but it will be appreciated that the casing 131 may be removably coupled to the gear box 116 in a different manner or the casing 131 may be fixedly coupled to the gear box 116. In the present example, the casing 131 is formed of a metal material (e.g., steel), but one of skill in the art will appreciate that any strong, rigid material may be suitable.

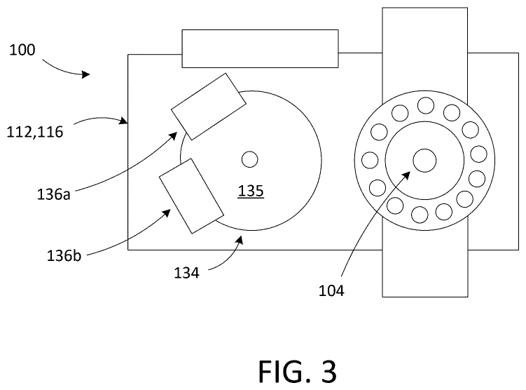

The parking brake assembly 134 includes the brake components for the electric drivetrain 100, namely a brake disk 135 operatively coupled to the multiplication gear assembly 124 and a plurality of brake calipers 136 configured to selectively engage the brake disk 135 to slow the rotation of the brake disk 135. In other words, the parking brake assembly 134 may be referred to herein as the electric parking brake assembly 134. In the present example, the brake disk 135 has a generally annular shape and includes an outer edge 135a and an opening 135b configured to receive the second shaft 128 to couple the second shaft 128 to the brake disk 135. It will be appreciated that the size of the brake disk 135 will vary depending on, for example, the size of vehicle (i.e., the torque necessary) and the ratio of the first gear 125 to the second gear 126. In other examples, the shape of the brake disk 135 may also vary depending upon the size of the vehicle and the ratio of the first gear 125 to the second gear 126. In the present example, the plurality of brake calipers 136, which may also be referred to as the parking brake calipers, includes two brake calipers 136, a first brake caliper 136a and a second brake caliper 136b each disposed along the outer edge 135a of the brake disk 135 and configured to selectively engage the brake disk 135 to slow (and stop) the rotation of the brake disk 135. In some examples, the first brake caliper 136a, 136b can be directly mounted to the casing 131. In any event, the first brake caliper 136a and the second brake caliper 136b operate independently of each other, such that the malfunction or failure of the first brake caliper 136a will not affect the functioning of the second brake caliper 136b (and vice versa). Moreover, the first and second brake calipers 136a, 136b independently create sufficient torque to slow and stop the rotation of the brake disk 135, thereby creating redundancy to ensure the parking brake assembly 134 remains effective in the event that one of the first and second brake calipers 136a, 136b malfunctions. Additionally, proportional braking might be achieved by using the first and second brake calipers 136a, 136b interchangeability, if required. In the present example, the first and second brake calipers 136a, 136b are electric calipers, but the first and second brake calipers 136a, 136b may instead be hydraulic or mechanical calipers. Additionally, while FIG. 3 illustrates the first and second brake calipers 136a, 136b in a specific position along the outer edge of the brake disk 135, it will be appreciated that the first and second brake calipers 136a, 136b may be disposed at any point along the outer edge of the brake disk 135. Finally, it will be appreciated that the parking brake assembly 134, the brake disk 135, and the plurality of brake calipers 136 may also be referred to herein as the brake assembly 134, the parking brake disk 135, and the plurality of brake calipers 136, respectively.

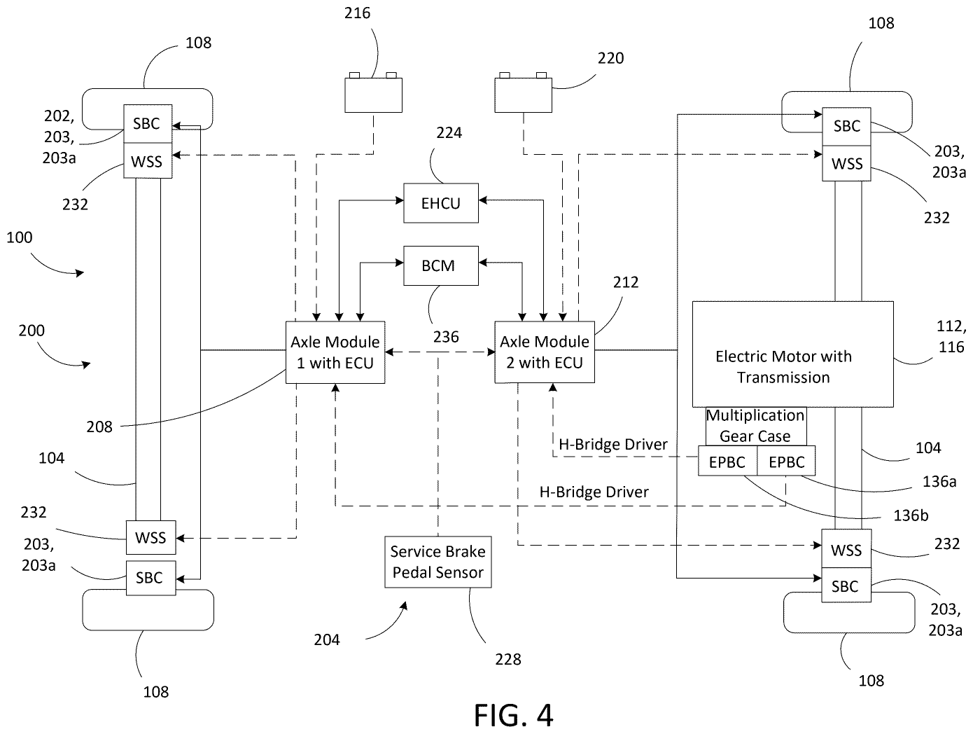

FIG. 4 illustrates one example of a braking system 200 that is constructed in accordance with the teachings of the present disclosure and is configured to be employed in a vehicle (e.g., a truck or other heavy-duty vehicle). The braking system 200 includes a service braking system 202, the electric drivetrain 100 of FIGS. 1-3, which in this example is integrated into and interfaces with the service braking system 202, and a control system 204 initially designed to control the service braking system 202 but also configured to control the electric drivetrain 100 once the electric drivetrain 100 is integrated into the braking system 200. The integration of the electric drivetrain 100 into the (different and existing) service braking system 200 beneficially enables a parallel path for electronic braking control and extended functionality and reliability.

The service braking system 202 includes a plurality of service brake assemblies 203 configured to serve as the primary brakes for the vehicle while in use (i.e., while the vehicle is in motion). In the present example, the service braking system 202 includes four service brake assemblies 203, one for each wheel 108 of the electric drivetrain 100 and one for each of the other two wheels 108 of the vehicle, and four service brake pedal sensors 203a, one for each of the four service brake assemblies 203. In other examples, however, the service braking system 202 can include more or less than four service brake assemblies 203. It will be appreciated that the service brake assemblies 203 each include a service brake disk, one or more service brake calipers 203a that are substantially similar to the brake disk 135 and the brake calipers 136, respectively, and one or more caliper sensors for each of the brake calipers 203a. However, the service brake assemblies 203 differ from the parking brake assembly 134 in a few respects. First, as shown in FIG. 4, each of the service brake assemblies 203 is disposed immediately adjacent one of the wheels 108 of the vehicle. Second, the service brake assemblies 203 are generally smaller in size and torque capacity as compared to the parking brake assembly 134 due to their placement along the wheels 108.

The control system 204 is connected (e.g., electro-hydraulically connected) to the service brake system 202 to control the service brake system 202. In the present example, the control system 204 includes a first electronic control unit (ECU) 208, a second ECU 212, a first power source 216, a second power source 220, and an electronic hand control unit 224. The first ECU 208 is electrically connected to the first brake caliper 136a, whereas the second ECU 212 is electrically connected to the second brake caliper 136b. The first power source 216 is electrically connected to the first brake caliper 136a, whereas the second power source 220 is electrically connected to the second brake caliper 136b. The electronic hand control unit 224 is electrically connected to the first and second ECUs 208, 212 and configured for sending an input to the first and second ECUs 208, 212 to activate the first and second brake calipers 136a, 136b, respectively. Moreover, in the present example, at least one of the service brakes assemblies 203 is connected (e.g., hydraulically connected) to the first ECU 208 and at least one of the service brakes assemblies 203 is connected (e.g., hydraulically connected) to the second ECU 212.

The first ECU 208 is generally intended to control the actuation of the first brake caliper 136a to slow the rotation of the parking brake disk 135 in response to an input from the electronic hand control unit 145. In the present example, the first ECU 208 is a computer configured for receiving or otherwise obtaining an input to direct functionality of a device as an output. In particular, the first ECU 208 is electrically connected to the electronic hand control unit 224 (i.e., the input) and the first brake caliper 136a and at least one of the service brake assemblies 203 (i.e., the output). In the present example, the first ECU 208 is electrically connected to two of the service brake assemblies 203, e.g., the service brake assemblies 203 associated with the front wheels 108 of the vehicle. The first ECU 208 is powered by the first power source 216. It will be appreciated that the first ECU 208 may be any type of computer or other processor suitable to implement the functionality discussed herein.

The second ECU 212 is substantially similar to the first ECU 208, but differs in at least two respects. First, the second ECU 212 is electrically connected to the second brake caliper 136b. Second, the second ECU 212 is electrically connected to second power source 220.

However, like the first ECU 208, the second ECU 212 is electrically connected to the electronic hand control unit 224 and at least one of the service brakes 203. In the present example, the second ECU 212 is electrically connected to the other two service brake assemblies 203, e.g., the service brake assemblies 203 associated with the rear wheels 108 of the vehicle. In any event, in the present example, the first and second brake calipers 136a, 136b are individually and separately connected to the first and second ECU, 208, 212, respectively, such that the first and second brake calipers 136a, 136b are independently controlled.

The first and second power sources 216, 220 and configured to power at least some of the electronic components of the system 200 including, for example, the first and second ECUs 208, 212. In the present example, each of the first and second power sources 216, 220 takes the form of a battery.

The electronic hand control unit 224 is intended to control the actuation of the parking brake assembly 134 (specifically the plurality of brake calipers 136) through the first and second ECUs 208, 212. In the present example, the electronic hand control unit 224 may be a mechanical component (e.g., a lever, button), an electrical component (e.g., touch screen), an electro-mechanical component, or other actuator electrically connected to the first and second ECUs 208, 212.

The system 200 further includes a service brake pedal sensor 228, a plurality of wheel speed sensors (WSS) 232 (which may be considered to be part of the plurality of service brake assemblies 203, respectively), and a body control module (BCM) 236. In the present example, the service brake pedal sensor 228 is disposed in the brake of the vehicle and is electrically connected to the first and second ECUs 208, 212. Moreover, the service brake pedal sensor 228 is generally intended to transmit a signal from an input (e.g., a brake pedal) to actuate the service brake assemblies 203. Each WSS 232 is disposed adjacent one of the service brake assemblies 203 and one of the wheels 108, and is intended to measure the rotational speed of each respective wheel 108 and transmit that data to one of the first and second ECUs 208, 212. The BCM 236 is a centralized computer control unit of the vehicle generally intended to control the functions of the vehicle not related to the drivetrain 100, including, for example, lighting, user interface functions, and other communications.

In operation, when a user of the vehicle (e.g., the driver) operates the electronic hand control unit 224 or the service brake pedal sensor 228, a request in the form of a signal or other communication is sent to the first and second ECUs 208, 212. Then, the first and second ECUs 208, 212 send a command to the parking brake assembly 134 or the service brake assemblies 203 to actuate the brake calipers 136 or the service brake calipers, respectively. This command causes the brake calipers 136 and/or the service brake calipers to exert a braking torque on the brake disk 135 of the parking brake assembly 134 or service brake disk, respectively. For the former, due to the actuation of the brake calipers 136, the parking brake assembly 134, which is operatively coupled to the gear box 116 and therefore the axle 104 and wheels 108, causes all rotation of the wheels 108 to cease. For the latter, the actuation of the service brake calipers at least partially reduces the rotation of the wheels 108 in response to the request from the service brake pedal sensor 228.

When in use, the system 200 benefits from redundancies built into the control system 204. First, the parking brake assembly 134 includes the first and second brake calipers 136a, 136b that each are capable of independently creating sufficient torque to ensure the parking brake assembly 134 is effective should one or the other malfunction. Second, the first and second brake calipers 136a, 136b are electrically connected independently to the first and second ECUs 208, 212, respectively, such that a malfunction one of the ECUs 208, 212 only corrupts the effectiveness of one of the first and second brake calipers 136a, 136b. Third, the first and second ECUs 208, 212 are independently powered by the first and second power sources 216, 220, respectively, such that failure of either of the first and second power sources 216, 220 only affects the effectiveness one of the first and second ECUs 208, 212. As a result of each of these redundancies, a failure of component (e.g., one power source, one ECU, or one brake caliper) does not compromise the effectiveness of the parking brake assembly 134.

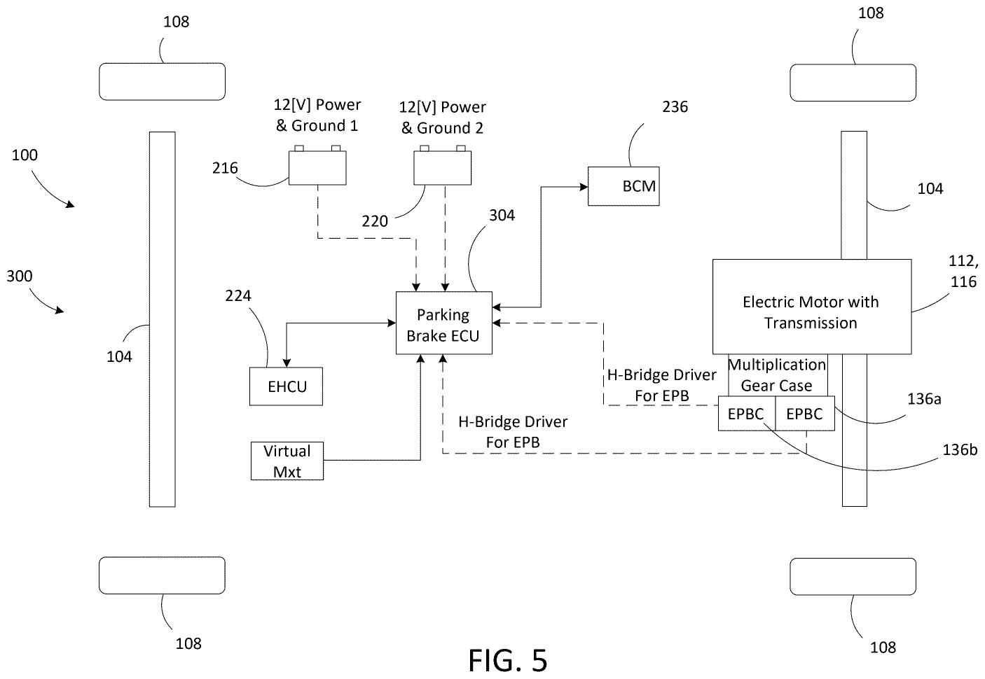

FIG. 5 illustrates another example of a braking system 300 that is constructed in accordance with the teachings of the present disclosure and is configured to be employed in a vehicle (e.g., a truck or other heavy-duty vehicle). The braking system 300 is similar to the braking system 200, in that the braking system 300 includes the electric drivetrain 100 of FIGS. 1-3. However, the braking system 300 differs from the system 200 in a few respects. First, the system 300 is a standalone parking brake system that includes, for example, the parking brake assembly 134 and the electronic hand control unit 224 of the system 200, but also includes a single, redundantly designed parking brake ECU 304 in place of the first and second ECUs 208, 212. In turn, the parking brake ECU 304 is electrically connected to both the first and second brake calipers 136a, 136b and configured to independently control actuation of each of the first and second brake calipers 136a, 136b. More particularly, the parking brake ECU 304 includes (i) more than one processor that works asynchronously and independently, each controlling an H-bridge driver to selectively actuate movement of the respective first and second brake calipers 136a, 136b, or (ii) a multicore processor with designated cores that work independently to individually control H-bridge drivers, thereby selectively actuating movement of the first and second brake calipers 136a, 136b, respectively. Second, while the system 300 includes the first and second power sources 216, 220, the system 300 differs from the system 200 in that both of the first and second power sources 216, 220 are electrically coupled to the parking brake ECU 304. In other words, the first and second power sources 216, 220 redundantly power the parking brake ECU 304. Alternatively, the braking system 300 can be designed so as to include two ECUs (e.g., ECUs 208, 212) instead of the single redundantly designed parking brake ECU 304, in which case the braking system 300 may be considered a partially redundant system (due to the redundant power functionality).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Numerous alternative examples could be implemented, using either current technology or technology developed after the filing date of this patent, which would still fall within the scope of the claims. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way, but may also be configured in ways that are not listed.

Further, unless expressly stated to the contrary, “or” refers to an inclusive or and not to an exclusive or. For example, “A, B or C” refers to any combination or subset of A, B, C such as (1) A alone, (2) B alone, (3) C alone, (4) A with B, (5) A with C, (6) B with C, and (7) A with B and with C. As used herein, the phrase “at least one of A and B” is intended to refer to any combination or subset of A and B such as (1) at least one A, (2) at least one B, and (3) at least one A and at least one B. Similarly, the phrase “at least one of A or B” is intended to refer to any combination or subset of A and B such as (1) at least one A, (2) at least one B, and (3) at least one A and at least one B.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter may lie in less than all features of a single disclosed example. Thus, the following claims are hereby incorporated into the Detailed Description, with each claim standing on its own as a separately claimed subject matter.

Finally, any references, including, but not limited to, publications, patent applications, and patents cited herein are hereby incorporated in their entirety by reference to the same extent as if each reference were individually and specifically indicated to be incorporated by reference and were set forth in its entirety herein.

The patent claims at the end of this patent application are not intended to be construed under 35 U.S. C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An electric drivetrain adapted to be installed in a vehicle to control movement of the vehicle, comprising:
a gear box adapted to be operatively coupled to wheels of the vehicle, wherein the gear box includes a differential;
a multiplication gear assembly operatively coupled to the differential; and
a parking brake assembly coupled to the multiplication gear assembly,
wherein the multiplication gear assembly comprises a first gear and a second gear operatively coupled to the first gear to reduce a braking torque required by the parking brake assembly to secure the vehicle in park.

2. The electric drivetrain of claim 1, the multiplication gear assembly further comprising:
a first shaft having a first end and second end opposite the first end, wherein the first end is coupled to at least a portion of the differential and the second end is coupled to the first gear; and
a second shaft coupled to the second gear,
wherein the first shaft and the second shaft rotate in opposite directions.

3. The electric drivetrain of claim 2, wherein the first shaft is arranged axially parallel to the second shaft.

4. The electric drivetrain of claim 2, wherein the first gear has an outer diameter that is greater than an outer diameter of the second gear.

5. The electric drivetrain of claim 1, the parking brake assembly comprising:
a brake disk operatively coupled to the multiplication gear assembly; and
a plurality of parking brake calipers operatively coupled to the brake disk,
wherein the plurality of parking brake calipers is configured to selectively engage the brake disk to slow the rotation of the brake disk.

6. The electric drivetrain of claim 5, wherein the plurality of parking brake calipers includes a first brake caliper and a second brake caliper that is operable independent of the first brake caliper.

7. The electric drivetrain of claim 1, wherein the multiplication gear assembly is removably coupled to the differential.

8. The electric drivetrain of claim 2, wherein the multiplication gear assembly further comprises a casing configured for enclosing at least a portion of the first shaft, the second shaft, the first gear, and the second gear.

9. The electric drivetrain of claim 8, wherein the first gear and the second gear are entirely disposed within the casing.

10. An electric drivetrain adapted to be installed in a vehicle, comprising:
an electric motor;
a gear box operatively coupled to the electric motor, wherein the gear box includes a differential;
a multiplication gear assembly operatively coupled to the differential; and
a parking brake assembly coupled to the multiplication gear assembly,
wherein the multiplication gear assembly comprises a first gear and a second gear operatively coupled to the first gear to reduce a braking torque required by the parking brake assembly to secure the vehicle in park,
and wherein the multiplication gear assembly is removably coupled to the gear box.

11. A drivetrain system adapted to be installed in a vehicle, comprising:
a gear box;
a multiplication gear assembly operatively coupled to the gear box;
an electric parking brake assembly operatively coupled to the multiplication gear assembly; and
a control system configured to selectively actuate the electric parking brake assembly,
wherein the multiplication gear assembly comprises a first gear and a second gear operatively coupled to the first gear to reduce a braking torque required by the electric parking brake assembly to secure the vehicle in park.

12. The system of claim 11, wherein the electric parking brake assembly comprises:
a parking brake disk operatively coupled to the multiplication gear assembly;
a plurality of parking brake calipers operatively coupled to the brake disk,
wherein the plurality of parking brake calipers is configured to selectively engage the parking brake disk to slow the rotation of the parking brake disk.

13. The system of claim 12, wherein the plurality of parking brake calipers comprises a first parking brake caliper and a second parking brake caliper operable independently of the first parking brake caliper.

14. The system of claim 13, wherein the control system comprises:
a first electronic control unit (ECU) electrically connected to the first parking brake caliper and configured to control the first parking brake caliper;
a second electronic control unit (ECU) electrically connected to the second parking brake caliper and configured to control the second parking brake caliper;
a first power source electrically connected to the first parking brake caliper;
a second power source electrically connected to the second parking brake caliper; and
an electronic hand control unit electrically connected to the first and second ECUs and configured for sending an input to the first and second ECUs to activate the first and second parking brake calipers, respectively.

15. The system of claim 14, further comprising a plurality of service brakes, wherein at least one of the plurality of service brakes is electrically connected to the first ECU and at least one of the plurality of service brakes is electrically connected to the second ECU.

16. The system of claim 13, the control system comprising:
one or more electronic control units (ECUs) electrically connected to at least one of the first and second parking brake calipers and configured to control at least one of the first and second parking brake calipers;
a first power source configured to power the ECUs;
a second power source configured to redundantly power the ECUs in the event the first power source fails, and
wherein the second parking brake caliper provides redundancy in the event the first parking brake caliper fails.

17. The system of claim 11, the multiplication gear assembly comprising:
a first shaft having a first end and second end opposite the first end, wherein the first end is coupled to at least a portion of the differential and the second end is coupled to the first gear; and
a second shaft coupled to the second gear,
wherein the first shaft and the second shaft rotate in opposite directions.

18. The system of claim 11, wherein the first gear has an outer diameter that is greater than an outer diameter of the second gear.

19. The system of claim 11, wherein the multiplication gear assembly is removably coupled to the gear box.

20. The system of claim 11, wherein the multiplication gear assembly further comprises a casing configured to enclose at least a portion of the first shaft, the second shaft, the first gear, and the second gear, wherein the first gear and the second gear are entirely disposed within the casing.
